(19) United States
(12) Patent Application Publication
(10) Pub. No.: US 2026/0002850 A1
(43) Pub. Date: Jan. 1, 2026

(54) A SAMPLE DELIVERY SYSTEM FOR AN ANALYTICAL INSTRUMENT

(71) Applicant: Agilent Technologies, Inc., Santa Clara, CA (US)

(72) Inventors: Brendan HAHESY, Santa Clara, CA (US); Anders KNUDTZEN, Santa Clara, CA (US); Philip Valmont WILSON, Santa Clara, CA (US)

(73) Assignee: Agilent Technologies, Inc., Santa Clara, CA (US)

(21) Appl. No.: 18/880,815

(22) PCT Filed: Jul. 11, 2023
(86) PCT No.: PCT/IB2023/057087

§ 371 Date: Jan. 2, 2025

(30) Foreign Application Priority Data
Jul. 15, 2022 (AU) 2022901996

(51) Int. Cl. G01N 1/38; H01J 49/04

(52) U.S. Cl. CPC G01N 1/38; H01J 49/0431; G01N 2001/383

(57) ABSTRACT

The invention provides a sample delivery system for an analytical instrument, comprising: a valve assembly comprising one or more valves, the valve assembly configured to receive an external sample from a sample source; an external sample reservoir coupled via the valve assembly to a sample dilution junction, wherein the valve assembly is configurable to alternatively permit either (i) flow of the external sample from the sample source to the external sample reservoir or (ii) flow of the external sample from the external sample reservoir to the sample dilution junction; a first fluid pump to control a flow of the external sample from the external sample reservoir to the sample dilution junction; a second fluid pump to control a flow of diluent to the sample dilution junction, thereby diluting the external sample to produce a diluted sample; and an analysis sample reservoir configured to deliver an analysis sample contained therein to an analysis device of the analytical instrument, wherein the analysis sample reservoir is coupled via the valve assembly to the sample dilution junction, and wherein the valve assembly is configurable to alternatively permit either (i) flow of the external sample along a continuous flow path from the sample source to the analysis sample reservoir, thereby by-passing the external sample reservoir, or (ii) flow of the diluted sample from the sample dilution junction to the analysis sample reservoir.

The present application claims priority from Australian provisional patent application No. 2022901996 filed on 15 Jul. 2022, the contents of which are to be understood to be incorporated into this specification by this reference.

### TECHNICAL FIELD

The invention relates to a sample delivery system for an analytical instrument, for example an inductively coupled plasma (ICP) spectrometer. The invention further relates to a spectrometer comprising the sample delivery system, and to a method of analysis using the spectrometer.

### BACKGROUND OF INVENTION

Inductively coupled plasma (ICP) spectrometry is an analytical technique used to detect and quantify the chemical elements and/or isotopic distributions of chemical elements present in liquid samples. An ICP spectrometer includes a plasma torch, powered by radio frequency (RF) generator, which ionises argon gas to generate an argon plasma at a temperature of about 7000K. The liquid sample to be analysed is typically nebulized to form an aerosol suitable for contact with the plasma. The plasma evaporates the sample solvent and breaks down the analyte molecules into their constituent atoms, which are ionised and/or excited to higher energy states. The elemental composition of the sample is then determined by measuring the optical emission spectrum of the sample (in an ICP-OES spectrometer) or the mass spectrum of the ionised sample (in an ICP-MS spectrometer).

ICP spectrometry is used as a routine analysis technique in a wide range of industries. There is a strong incentive to automate the operation of ICP spectrometers, thus minimising the involvement of human operators, and to maximise the average rate at which samples can be analysed in ICP spectrometers, thus increasing the instrument productivity.

ICP spectrometers generally require regular calibration by analysing standard solutions containing known concentrations of each analyte element and creating a calibration curve. The calibration curve will span a range of concentrations covering the typically expected concentrations in the samples to be analysed and/or the concentrations within a range where the instrument provides a linear response. However, it is common in practice that some samples (for example, up to 20%) will be over-range for one or more analytes. Thus, to obtain an accurate quantification, it is necessary to dilute the sample to ensure that the over-range analytes are within the calibration range, re-analyse the diluted sample and back-calculate the analyte concentrations in the undiluted sample based on the known dilution level of the diluted sample.

Various different approaches have previously been used for sample dilution with ICP-MS and ICP-OES instruments. Most basically, samples are diluted manually or by automated off-line dilution, to pre-determined dilution levels, prior to the analysis. However, systems which are not able to dilute to instrument requested levels do not offer the benefit of automatically diluting samples found to be over-range and thus have only a limited impact on instrument productivity. Other systems can provide automated off-line sample dilution or on-line sample dilution (in the autosampler) to instrument requested dilution levels, but there is a risk of carry over because all samples are diluted in the same dilution vial.

Various in-line sample dilution systems have previously been proposed. U.S. Pat. No. 9,239,581 discloses a sample delivery system for an ICP spectrometer where a diluent can be mixed with the flow of sample immediately before it is delivered to the nebulizer. However, ICP spectrometers require a near-constant, low flow rate of liquid to the nebulizer to maintain stability of the plasma, whereas the flow to the nebulizer is disrupted between dilutions with the sampling arrangement of U.S. Pat. No. 9,239,581.

U.S. Pat. Nos. 10,241,013 and 11,056,328 both disclose in-line dilution systems with two modules. In the first (sample dilution) module, an external sample is loaded from an autosampler to a first sample loop. The sample is subsequently flowed from the first sample loop and diluted in-line with a flow of diluent to produce a diluted sample having a target dilution level. The diluted sample is transferred to the second (sample delivery) module where it is loaded into a second sample loop. The diluted sample is subsequently flowed out of the second sample loop and delivered to the ICP analyser. While this arrangement provides for accurate in-line dilution of a sample across a wide range of dilution levels, it has the disadvantage that all samples must pass through both modules of the in-line dilution system, even if dilution is not required. Transferring the sample through the sample dilution module adds significant time to the analysis, with the undesirable impacts on instrument productivity particularly apparent in use scenarios where only a minority of the samples require dilution. Moreover, the first sample loop must hold a significantly greater volume than the second sample loop to allow for representative transfer of undiluted sample to the second loop for analysis.

While the foregoing discussion has focused on ICP-spectrometry, it will be apparent that similar considerations apply to sample delivery systems for a range of other analytical instruments, including but not limited to other spectrometers containing a plasma source for sample treatment, such as microwave plasma spectrometers.

There is therefore an ongoing need for sample delivery systems for analytical instruments, which at least partially address one or more of the above-mentioned short-comings, or provide a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

The present invention provides a sample delivery system for an analytical instrument which can operate in two modes. In the first mode, the sample delivery system is configured to provide a continuous flow path from a sample source (such as an autosampler) to an analysis sample reservoir (typically configured as a sample loop). An external sample can thus be directly loaded from the sample source to the analysis sample reservoir, and unloaded without in-line dilution to the analyser via a single (sample delivery) module. In the second mode, the sample delivery system is configured for in-line dilution and sample delivery via two modules. In the sample dilution module, the external sample is loaded initially to an external sample reservoir (optionally also configured as a sample loop), then subsequently flowed from the external sample reservoir and diluted in-line by a controlled flow of diluent. The diluted sample is transferred to the sample delivery module where it is flowed to the analysis sample reservoir, and subsequently unloaded to the analyser similarly to the first mode of operation. Because the sample dilution module is by-passed in the first mode, undiluted samples can be rapidly analysed. The sample dilution module is only engaged for those samples where dilution is required, thus minimising the impact on the overall instrument productivity. Moreover, the by-pass arrangement allows the size of the external sample reservoir to be reduced because the external sample held therein is always diluted when transferred to the analysis sample reservoir.

In accordance with a first aspect, the invention provides a sample delivery system for an analytical instrument, comprising: a valve assembly comprising one or more valves, the valve assembly configured to receive an external sample from a sample source; an external sample reservoir coupled via the valve assembly to a sample dilution junction, wherein the valve assembly is configurable to alternatively permit either (i) flow of the external sample from the sample source to the external sample reservoir or (ii) flow of the external sample from the external sample reservoir to the sample dilution junction; a first fluid pump to control a flow of the external sample from the external sample reservoir to the sample dilution junction; a second fluid pump to control a flow of diluent to the sample dilution junction, thereby diluting the external sample to produce a diluted sample; and an analysis sample reservoir configured to deliver an analysis sample contained therein to an analysis device of the analytical instrument, wherein the analysis sample reservoir is coupled via the valve assembly to the sample dilution junction, and wherein the valve assembly is configurable to alternatively permit either (i) flow of the external sample along a continuous flow path from the sample source to the analysis sample reservoir, thereby by-passing the external sample reservoir, or (ii) flow of the diluted sample from the sample dilution junction to the analysis sample reservoir.

In some embodiments, the analysis sample reservoir is configured as an analysis sample loop coupled to two ports of a first multiport valve of the valve assembly, wherein an analysis sample is loadable into the analysis sample loop when the first multiport valve is in a first valve position and wherein the analysis sample is deliverable from the analysis sample loop to the analysis device when the first multiport valve is switched to a second valve position. The sample delivery system may further comprise a third fluid pump to flow a first carrier fluid to the first multiport valve, wherein the first multiport valve is configurable to flow the first carrier fluid directly through the first multiport valve to the analysis device when the first multiport valve is in the first valve position and to divert the first carrier fluid through the analysis sample loop when the first multiport valve is switched to the second valve position, thereby delivering the analysis sample from the analysis sample loop to the analysis device. Optionally, the sample delivery system may further comprise a bubble injector configured to inject a bubble of gas to space apart the first carrier fluid from the analysis sample when the first carrier fluid flows through the analysis sample loop.

In some embodiments, the sample delivery system further comprises a fourth fluid pump or vacuum source, preferably located downstream of the analysis sample reservoir, to flow the external sample along the continuous flow path from the sample source to the analysis sample reservoir. The sample delivery system may be adapted to bypass the fourth fluid pump or vacuum source when the diluted sample is flowed from the sample dilution junction to the analysis sample reservoir. The valve assembly may be configurable to permit the fourth fluid pump or vacuum source to flow the external sample from the sample source to the external sample reservoir.

In some embodiments, the valve assembly is configurable to permit the first fluid pump to flow the external sample from the sample source to the external sample reservoir.

In some embodiments, the valve assembly comprises a second multiport valve coupled to the analysis sample reservoir, wherein the second multiport valve is switchable between at least a first valve position to permit the flow of the external sample along the continuous flow path from the sample source to the analysis sample reservoir and a second valve position to permit the flow of the diluted sample from the sample dilution junction to the analysis sample reservoir. The second multiport valve may be switchable to a third valve position to permit the flow of the external sample from the sample source to the external sample reservoir. The second fluid pump may control the flow of diluent through the second multiport valve to the sample dilution junction when the second multiport valve is switched to the second valve position. Optionally, the sample dilution junction is inside the second multiport valve.

In some embodiments, the external sample reservoir is configured as an external sample loop coupled to a valve of the valve assembly.

In some embodiments, the external sample reservoir is configured as an external sample loop coupled to two ports of a third multiport valve of the valve assembly, wherein the external sample is loadable into the external sample loop when the third multiport valve is in a second valve position and wherein the external sample is deliverable from the external sample loop to the sample dilution junction when the third multiport valve is switched to a first valve position. The valve assembly may be configurable to permit the first fluid pump to flow a second carrier fluid through the external sample loop when the third multiport valve is switched to the first valve position, thereby flowing the external sample from the external sample loop to the sample dilution junction. The sample delivery system may be configurable to introduce a gas bubble to space apart the second carrier fluid and the external sample when the second carrier fluid flows through the external sample loop. The valve assembly may be configurable to permit the second fluid pump to flow the diluent through the third multiport valve to the sample dilution junction when the third multiport valve is in the first valve position. Optionally, the sample dilution junction is inside the third multiport valve. The valve assembly may be configurable to permit the flow of the external sample along the continuous flow path from the sample source to the analysis sample reservoir via the third multiport valve when the third multiport valve is in the first valve position.

In some embodiments, the first fluid pump and the second fluid pump are configured to flow the external sample and the diluent at relative flow rates (v/v) in the range of from 10:1 to 1:1000, for example in the range of from 1:1 to 1:250.

In some embodiments, the first fluid pump and the second fluid pump are configured to flow the external sample and the diluent at a combined flow rate of between 2 and 20 ml/min, for example between 5 and 15 ml/min, such as about 10 ml/min.

In some embodiments, the volume of the external sample reservoir is no more than 20% greater than the volume of the analysis sample reservoir. In some embodiments, the volume of the external sample reservoir is no greater than the volume of the analysis sample reservoir.

In some embodiments, the sample delivery system further comprises the sample source, wherein the sample source is coupled via the valve assembly to the external sample reservoir and to the analysis sample reservoir. The sample source may be selected from the group consisting of an autosampler and an automation interface adapted to sample a process fluid.

In accordance with a second aspect, the invention provides a spectrometer comprising a sample delivery system according to any embodiment of the first aspect, and an analysis device.

In some embodiments, the analysis device comprises a plasma source.

In some embodiments, the spectrometer is an ICP-OES and/or an ICP-MS spectrometer.

In some embodiments, the spectrometer further comprises a computing device for controlling the sample delivery system to deliver an external sample for spectroscopic analysis by either method (a) or method (b), wherein: method (a) comprises: (i) flowing the external sample along the continuous flow path from the sample source to the analysis sample reservoir, without dilution thereof, and (ii) subsequently delivering the external sample from the analysis sample reservoir to the analysis device for spectroscopic analysis, and method (b) comprises: (i) flowing the external sample from the sample source to the external sample reservoir, (ii) subsequently flowing the external sample from the external sample reservoir to the sample dilution junction, (iii) simultaneously flowing diluent to the sample dilution junction, thereby diluting the external sample to produce a diluted sample, (iv) flowing the diluted sample from the sample dilution junction to the analysis sample reservoir, and (v) subsequently delivering the diluted sample from the analysis sample reservoir to the analysis device for spectroscopic analysis.

In some embodiments, the computing device is adapted to: deliver a first external sample for spectroscopic analysis by method (a); determine, based on the spectroscopic analysis of the first external sample, a target dilution of the first external sample; and deliver a diluted sample, comprising the first external sample and the diluent, for spectroscopic analysis by method (b), wherein the first fluid pump and the second fluid pump are controlled to flow the first external sample and the diluent at relative flow rates suitable to achieve the target dilution in the diluted sample.

In accordance with a third aspect, the invention provides a method of analysis using a spectrometer according to any embodiment of the second aspect, comprising: providing one or more external samples at a sample source for analysis; and analysing at least a first sample of the one or more external samples, without dilution of the first sample, by a first analysis methodology comprising: (i) flowing the first sample along the continuous flow path from the sample source to the analysis sample reservoir, and (ii) subsequently delivering the first sample from the analysis sample reservoir to the analysis device for spectroscopic analysis.

In some embodiments, the method comprises analysing at least the first sample or a second sample of the one or more external samples, with in-line dilution of the first or second sample, by a second analysis methodology comprising: (i) flowing the first or second sample from the sample source to the external sample reservoir, (ii) subsequently flowing the first or second sample from the external sample reservoir to the sample dilution junction, (iii) simultaneously flowing diluent to the sample dilution junction, thereby diluting the first or second sample to produce a diluted sample, (iv) flowing the diluted sample from the sample dilution junction to the analysis sample reservoir, and (v) subsequently delivering the diluted sample from the analysis sample reservoir to the analysis device for spectroscopic analysis.

In some such embodiments, the method may further comprise determining, based on the spectroscopic analysis of the first sample obtained by the first analysis methodology, a target dilution of the first sample; and analysing the first sample by the second analysis methodology, wherein the first fluid pump and the second fluid pump of the sample delivery system are controlled to flow the first sample and the diluent at relative flow rates suitable to achieve the target dilution in the diluted sample.

In other such embodiments, the method may further comprise providing a calibration sample at the sample source for analysis, the calibration sample having a known concentration of one or more analytes; analysing the calibration sample by the first analysis methodology, thereby delivering the calibration sample to the analysis device for spectroscopic analysis; and analysing the calibration sample one or more times by the second analysis methodology, thereby delivering one or more diluted calibration samples having known concentrations of the one or more analytes to the analysis device for spectroscopic analysis.

In some embodiments, the method comprises providing a plurality of external samples at the sample source for analysis; analysing the plurality of external samples by the first analysis methodology; identifying, based on the spectroscopic analyses of the plurality of external samples, any over-range samples of the plurality of external samples having a concentration of an analyte greater than a predetermined maximum concentration; and analysing the over-range samples, if identified, by a second analysis methodology, with in-line dilution of the over-range samples, by a second analysis methodology comprising: (i) flowing the over-range sample from the sample source to the external sample reservoir, (ii) subsequently flowing the over-range sample from the external sample reservoir to the sample dilution junction, (iii) simultaneously flowing diluent to the sample dilution junction, thereby diluting the over-range sample to produce a diluted sample having a concentration of the analyte less than the predetermined maximum concentration, (iv) flowing the diluted sample from the sample dilution junction to the analysis sample reservoir, and (v) subsequently delivering the diluted sample from the analysis sample reservoir to the analysis device for spectroscopic analysis.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

As used herein, the terms “first”, “second”, “third” etc in relation to various features of the disclosed devices are arbitrarily assigned and are merely intended to differentiate between two or more such features that the device may incorporate in various embodiments. The terms do not of themselves indicate any particular orientation or sequence. Moreover, it is to be understood that the presence of a “first” feature does not imply that a “second” feature is present, the presence of a “second” feature does not imply that a “first” feature is present, etc.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 schematically depicts a sample delivery system 100, according to an embodiment of the invention, comprising a valve assembly of three multiport valves which are switchable between first and second valve positions. First multiport valve 104 is in its first valve position, second multiport valve 106 is in its first valve position and third multiport valve 108 is in its first valve position.

FIG. 2 schematically depicts sample delivery system 100 with first multiport valve 104 in its second valve position, second multiport valve 106 in its first valve position and third multiport valve 108 in its first valve position.

FIG. 3 schematically depicts sample delivery system 100 with first multiport valve 104 in its first valve position, second multiport valve 106 in its second valve position and third multiport valve 108 in its second valve position.

FIG. 4 schematically depicts sample delivery system 100 with first multiport valve 104 in its first valve position, second multiport valve 106 in its second valve position and third multiport valve 108 in its first valve position.

FIG. 5 schematically depicts sample delivery system 100 with first multiport valve 104 in its second valve position, second multiport valve 106 in its second valve position and third multiport valve 108 in its second valve position.

FIG. 6 schematically depicts a sample delivery system 200, according to an embodiment of the invention, comprising a valve assembly of two multiport valves. First multiport valve 204, which is switchable between first and second valve positions, is in its first valve position. Second multiport valve 206, which is switchable between first, second and third valve positions, is in its first valve position.

FIG. 7 schematically depicts sample delivery system 200 with first multiport valve 204 in its second valve position and second multiport valve 206 in its first valve position.

FIG. 8 schematically depicts sample delivery system 200 with first multiport valve 204 in its second valve position and second multiport valve 206 in its third valve position.

FIG. 9 schematically depicts sample delivery system 200 with first multiport valve 204 in its first valve position and second multiport valve 206 in its second valve position.

FIG. 10 schematically depicts a sample delivery system 300, according to an embodiment of the invention, comprising a valve assembly of two multiport valves. First multiport valve 204, which is switchable between first and second valve positions, is in its first valve position. Second multiport valve 206, which is switchable between first, second and third valve positions, is in its second valve position.

FIG. 11 is a flow diagram illustrating a method of analysis 1100 using a spectrometer according to embodiments of the invention.

### DETAILED DESCRIPTION

The present invention relates to a sample delivery system for an analytical instrument. The sample delivery system comprises a valve assembly comprising one or more valves, and configured to receive an external sample from a sample source, such as an autosampler. The sample delivery system comprises an external sample reservoir (e.g. in the form of a sample loop) coupled via the valve assembly to a sample dilution junction and, in use, to the sample source. The valve assembly is configurable to permit, in the alternative, either (i) flow of external sample from the sample source to the external sample reservoir, or (ii) flow of external sample from the external sample reservoir to the sample dilution junction. A representative aliquot of the external sample can thus be sequentially transferred into, and then transferred out of, the external sample reservoir. The sample delivery system comprises a first fluid pump to control the flow of the external sample from the external sample reservoir to the sample dilution junction, and a second fluid pump to control the flow of diluent to the sample dilution junction, thereby diluting the external sample to produce a diluted sample.

The sample delivery system further comprises an analysis sample reservoir (e.g. in the form of a sample loop) configured to deliver an analysis sample contained therein to an analysis device of an analytical instrument. The analysis sample reservoir is coupled via the valve assembly to the sample dilution junction and, in use, to the sample source. The valve assembly is configurable to permit, in the alternative, either (i) flow of the external sample along a continuous flow path from the sample source to the analysis sample reservoir, thereby by-passing the external sample reservoir, or (ii) flow of the diluted sample from the sample dilution junction to the analysis sample reservoir.

### Valve Assembly

The sample delivery system comprises a valve assembly comprising one or more valves, for example two or more valves, such as two or three valves. In some embodiments, one or more of the valves are multiport switching valves, capable of switching between at least two discrete valve positions (e.g. two or three valve positions) to reconfigure the internal flow channels of the valve between the ports of the valve. Suitable multiport valves may be rotary switching valves comprising at least 4, and commonly at least 5, 6 or 7 ports. In some exemplary embodiments, the valve assembly comprises one or more seven-port rotary valves, for example Cheminert switching valves supplied by Valco Instruments Company Inc. (VICI). The valve assembly may comprise one or more other types of valves, for example solenoid or shutoff valves. As the skilled person will appreciate, a valve assembly consistent with the principles disclosed herein may include a wide range of valve types and configurations.

The valve assembly is configured to receive an external sample from a sample source, such as an autosampler, and to deliver that sample, either undiluted or diluted, for analysis in an analysis device (e.g. an analysis device comprising an plasma source, such as in an ICP spectrometer), optionally via a nebulizer. The valve assembly may comprise various fluid flow lines, including (i) a sample source line, coupled to a valve of the valve assembly, by which the external sample is received from the sample source, (ii) one or more sample transfer lines, each coupled to two valves of the valve assembly, for transferring sample or other fluids between valves, and (iii) a sample delivery line, coupled to a valve of the valve assembly, to deliver a sample for analysis to the analysis device. These lines, and the internal flow channels between ports inside the valves, are generally narrow (e.g. 1 or 2 mm internal diameter) to allow fluids to flow in substantially plug flow mode through the valve assembly.

As used herein, when two components are “coupled”, it means that the components are connected to allow fluid flow therebetween, either directly or via other components, and provided that the valve assembly has been configured to permit such flow.

### External Sample Reservoir

The sample delivery system comprises an external sample reservoir coupled via the valve assembly to a sample dilution junction. The valve assembly is configurable to permit, in the alternative, either (i) flow of an external sample from a sample source to the external sample reservoir (i.e. loading), or (ii) flow of an external sample retained in the external sample reservoir to the sample dilution junction (i.e. unloading).

As used herein, an external sample reservoir is adapted to receive and hold a representative aliquot of an external sample, sufficient in volume to be transferred, with subsequent dilution to a required dilution level, for analysis. Preferably, the external sample reservoir comprises a narrow fluid line (e.g. 1 or 2 mm internal diameter) of sufficient length to provide the required holding capacity, thus allowing fluids to flow into and out of the external sample reservoir in substantially plug flow mode.

In some embodiments, the external sample reservoir is configured as a sample loop (“external sample loop”) coupled to two ports of a multiport valve of the valve assembly. In this case, the external sample can be loaded into the external sample loop when the multiport valve is in one valve position and delivered from the external sample loop to the sample dilution junction when the multiport valve is switched to another valve position. The flow of external sample into the external sample loop may be driven by a fluid pump, e.g. a high flow rate piston pump or vacuum pump, or a vacuum source, preferably located downstream of the valve assembly in the flow path to a drain (sample waste).

Other configurations of the external sample reservoir are also envisaged. For example, the external sample reservoir may comprise a line coupled at only one end to a multiport valve of the valve assembly. Optionally, the other end may be coupled to a reversible fluid pump. In this case, the external sample can be loaded into and discharged from the external sample reservoir using the reversible fluid pump.

### First and Second Fluid Pumps, and Sample Dilution Junction

The sample delivery system comprises first and second fluid pumps to control the extent of dilution of the external sample, when dilution is required. The first fluid pump controls the flow of external sample from the external sample reservoir to the sample dilution junction, and the second fluid pump controls the flow of diluent from a diluent source to the sample dilution junction. The two independently controllable flows thus converge at the sample dilution junction, thereby diluting the external sample to produce a diluted sample.

In some embodiments, the first fluid pump flows a carrier fluid through the external sample reservoir, thereby flowing (“pushing”) the external sample from the external sample reservoir to the sample dilution junction. The use of a carrier fluid provides the advantage that the external sample never comes into contact with the first fluid pump. Optionally, the system may be adapted to introduce a gas bubble to space apart the carrier fluid and the external sample, thus avoiding or acceptably limiting the mixing between the two fluids.

In some embodiments, the second fluid pump is located upstream of the sample dilution junction, thus acting directly on the diluent as it flows the diluent from a diluent source (e.g. a tank, or internal volume of the pump) through the second fluid pump to the sample dilution junction. However, it is not required that the second fluid pump acts directly on the diluent. For example, the second fluid pump may be located downstream of the sample dilution junction, and preferably downstream of the valve assembly in the flow path to a drain (sample waste). The second fluid pump acts directly on the diluted sample, or other fluid further downstream in the flow path, thereby accurately controlling the total combined flow of the external sample and the diluent. The first fluid pump accurately controls the flow rate of the external sample only. The diluent is thus drawn to the sample dilution junction at the required flow rate, i.e. as the difference between the flow rates of the first and second fluid pumps. In this way, the second fluid pump indirectly controls the flow of diluent to the sample dilution junction.

It will also be appreciated that the first fluid pump may be located downstream to accurately control the total combined flow of the external sample and diluent, while the second fluid pump accurately controls the flow of diluent only. Thus, the first fluid pump indirectly controls the flow of external sample to the sample dilution junction. In all cases, the sample delivery system must remain suitably configured to allow an initial transfer of external sample from the sample source to the sample reservoir, before the subsequent dilution step where the first and second fluid pumps are operated as described herein.

The first and second fluid pumps may suitably be syringe pumps, or other positive displacement pumps such as a piston pumps, which are capable of accurately controlling fluid flow rates in the required ranges. Alternatively, pumps can be used in combination with a flow meter to accurately control the flow. In some embodiments, the first fluid pump and the second fluid pump are configured to flow the external sample and the diluent at relative flow rates (v/v) in the range of from 10:1 to 1:1000, such as in the range of from 1:1 to 1:400, such as from 1:1 to 1:250. In some embodiments, the first fluid pump and the second fluid pump are configured to flow the external sample and the diluent at a combined flow rate of between 2 and 20 ml/min, preferably between 5 and 15 ml/min, such as about 10 ml/min.

The controlled flows of external sample and diluent converge at the sample dilution junction, so that the external sample is diluted to produce a diluted sample having the required dilution level. The sample dilution junction may optionally be inside a multiport valve of the valve assembly, e.g. at a port of the valve, such as where two internal flow channels through the valve converge. However, any sample dilution junction configuration capable of converging and subsequently mixing the two flows is encompassed.

### Analysis Sample Reservoir

The sample delivery system comprises an analysis sample reservoir configured to deliver an analysis sample contained therein to the analysis device. The analysis sample reservoir is coupled via the valve assembly to the sample dilution junction and, at least in use, to the sample source, and the valve assembly is configurable to permit, in the alternative, either (i) flow of the external sample along a continuous flow path from the sample source to the analysis sample reservoir, thereby by-passing the external sample reservoir (i.e. loading an undiluted analysis sample), or (ii) flow of the diluted sample from the sample dilution junction to the analysis sample reservoir (i.e. loading a diluted analysis sample).

As used herein, an analysis sample reservoir is adapted to receive and hold a representative aliquot of a diluted or undiluted sample, sufficient in volume for subsequent transfer to an analyser (e.g. via a nebulizer) for spectroscopic analysis. Preferably, the analysis sample reservoir comprises a narrow fluid line (e.g. 1 or 2 mm internal diameter) of sufficient length to provide the required holding capacity, thus allowing fluids to flow into and out of the analysis sample reservoir in substantially plug flow mode.

The flow of the external sample along the continuous flow path from the sample source to the analysis sample reservoir may be driven by a fluid pump, e.g. a high flow rate piston pump or vacuum pump, or a vacuum source, preferably located downstream of the analysis sample reservoir in the flow path to a drain (sample waste). The flow of the diluted sample from the sample dilution junction to the analysis sample reservoir is driven by the first and second fluid pumps.

In some embodiments, the analysis sample reservoir is configured as a sample loop (“analysis sample loop”) coupled to two ports of a multiport valve of the valve assembly. In this case, the analysis sample can be loaded into the analysis sample loop when the multiport valve is in one valve position and delivered from the analysis sample loop to the analysis device when the multiport valve is switched to another valve position. Optionally, a fluid pump may be provided to flow a carrier fluid directly through the multiport valve to the analysis device when the multiport valve is in the first valve position and to divert the carrier fluid through the analysis sample loop when the multiport valve is switched to the second valve position. This delivers (“pushes”) the analysis sample from the analysis sample loop to the analysis device without interrupting the continuous flow of liquid to the analyser. Optionally, the system may comprise a bubble injector to inject a bubble of gas to space apart the carrier fluid from the analysis sample.

Other configurations of the analysis sample reservoir are also envisaged. For example, the analysis sample reservoir may comprise a line coupled at only one end to a multiport valve of the valve assembly. The other end may be coupled to a reversible fluid pump. In this case, the analysis sample can be loaded into and discharged from the analysis sample reservoir using the reversible fluid pump.

A feature of the sample delivery systems disclosed herein is that an external sample stored in the external sample reservoir is always diluted when it is transferred to the analysis sample reservoir in the normal course of operation. Therefore, the external sample reservoir can have a smaller volume (sample holding capacity) than would be the case if it was required to transfer a representative external sample without dilution to the analysis sample reservoir. As an example, the external sample reservoir and the analysis sample reservoir may be approximately equal in size. If the minimum dilution ratio is 1:1, this provides ample volume of diluted sample to flush out the analysis sample loop and leave a representative aliquot of the diluted sample in the analysis sample loop. Advantageously, the analysis sample system thus requires no more sample than an otherwise comparable sample delivery system with an analysis sample reservoir but without in-line dilution capability.

### Sample Source

The sample delivery system may comprise a sample source to provide one or more external samples for analysis. As used herein, an external sample is a sample provided externally to and upstream of the sample delivery system. The sample source may be permanently or removably coupled to the valve assembly via a sample source line. In use, the sample source is located upstream of all valves of the valve assembly, and in particular it is not an in-line sample loop coupled to a valve of the valve assembly.

The sample source may be an autosampler adapted to sequentially sample a plurality of discrete external samples provided for analysis (e.g. in sample vials). Optionally, such an autosampler may also contain a rinse source which may be used to flush the valve assembly and either of the sample reservoirs in various modes of operation.

It will be appreciated, however, that the sample source can in principle be any vessel or apparatus which can provide an external sample for analysis via the valve assembly. For example, analytical instruments such as ICP spectrometers can be integrated into industrial processes for online monitoring purposes, and in such cases the sample source may take the form of an automation interface comprising one or more pumps, selection valves etc and adapted to sample a process fluid. The automation interface may even subject the primary sample to one or more sample preparation processes, including (but not limited to) digestion and reagent addition, thereby providing a pre-processed external sample for transfer to the valve assembly of the sample delivery system.

### EXEMPLARY EMBODIMENTS

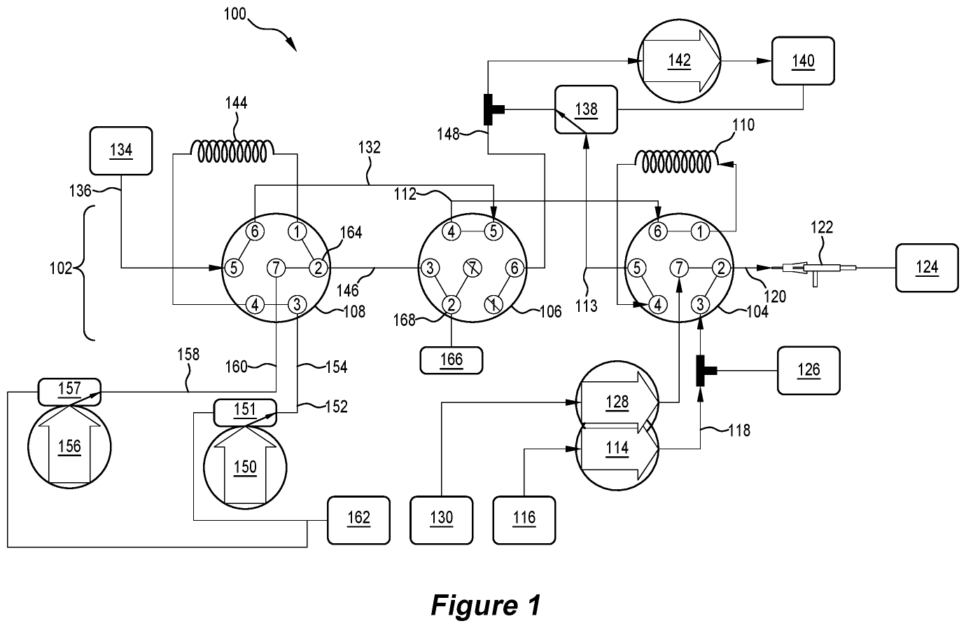

Depicted in FIGS. 1 to 5 is a sample delivery system 100 according to embodiments of the invention. System 100 includes a valve assembly 102 comprising first multiport valve 104, second multiport valve 106 and third multiport valve 108, each of which is switchable between first and second valve positions in which three internal flow channels of the valve provide a different set of connections between two ports of the valve. Multiport valves 104, 106 and 108 may each be seven-port rotary valves. Second multiport valve 106 does not utilise all seven ports, and the unutilized ports 1 and 7 are simply blocked. Alternatively, valve 106 could be a custom-built five-port valve.

First multiport valve 104 is coupled to analysis sample loop 110, which is connected to ports 1 and 4 of valve 104. Analysis sample loop 110 comprises a coil of small diameter tubing (e.g. 1 or 2 mm internal diameter) with sufficient volume (application dependent, e.g. 0.25 to 4 ml, such as 1 to 2 ml) to hold an analysis sample for subsequent analysis in analysis device 124. Valve 104 is also coupled to second multiport valve 106 via loading line 112, which is connected to port 6 of valve 104 and port 4 of valve 106. When first multiport valve 104 is in its first valve position, as depicted in FIG. 1, an analysis sample is loadable into analysis sample loop 110 by flowing an undiluted or diluted sample to be analysed from loading line 112, through analysis sample loop 110 and out of port 5 of valve 104 to drain line 113, with the flow continued at least until analysis sample loop 110 holds a representative sample.

System 100 further comprises third fluid pump 114 to flow first carrier fluid 116 (also known as a rinse) to first multiport valve 104 via carrier fluid line 118, which is connected to port 3 of valve 104. Third fluid pump 114 may be a peristaltic pump configured to deliver a substantially constant flow rate of the carrier fluid in use (application dependent, e.g. 0.3 ml/min for ICP-MS and 1 ml/min for ICP-OES). When first multiport valve 104 is in its first valve position, as depicted in FIG. 1, pump 114 flows first carrier fluid 116 directly through valve 104, exiting via port 2, and then proceeding via sample delivery line 120 to nebuliser 122. The nebulised microdroplets may then be classified in a spray chamber (not shown) and sent to analysis device 124 (e.g. an ICP-OES or ICP-MS analyser).

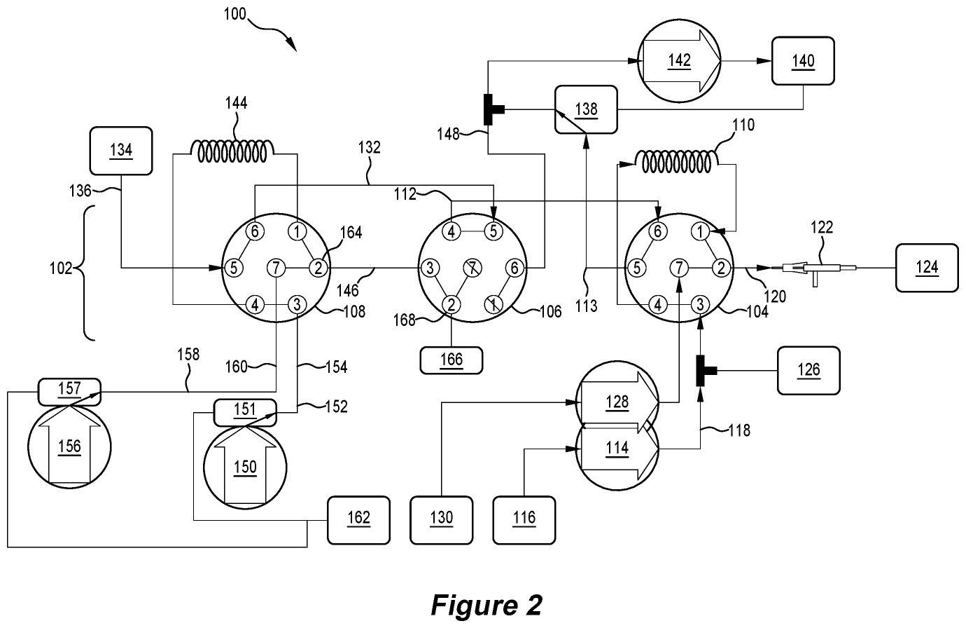

Once an analysis sample, representative of the undiluted or diluted sample to be analysed, has been loaded in analysis sample loop 110, the analysis sample is then delivered via sample delivery line 120 to nebulizer 122 by switching first multiport valve 104 to its second valve position, as depicted in FIG. 2. The flow of first carrier fluid 116 is thus diverted through analysis sample loop 110, pushing the analysis sample out of valve 104 via sample delivery line 120 to nebulizer 122, where it is nebulized and subsequently analysed in analysis device 124.

System 100 may optionally include bubble injector 126 configured to inject a bubble of gas (e.g. pressurised argon) into carrier fluid line 118 immediately before its connection to port 3 of valve 104. The bubble is injected as first multiport valve 104 is switched to its second valve position to divert first carrier fluid 116 through analysis sample loop 110. The bubble thus physically spaces apart first carrier fluid 116 from the analysis sample as the carrier fluid flows through the analysis sample loop and pushes the analysis sample to nebulizer 122. This prevents or mitigates any undesired dilution of the analysis sample while it is carried to nebulizer 122.

System 100 may further comprise a fifth fluid pump 128, optionally also a peristaltic pump, to flow internal standard 130 to sample delivery line 120. Typically, pumps 114 and 128 are two channels of a single peristaltic pump unit, which advantageously ensures a consistent ratio of the flows of internal standard 30 and first carrier fluid 116. The flow of internal standard 130 may be directed through first multiport valve 104, entering port 7 and exiting port 2 regardless of whether valve 104 is in its first or second valve position, as depicted in FIGS. 1 and 2. The internal standard thus mixes with the flow of first carrier fluid 116 and/or the analysis sample before it reaches nebulizer 122. Alternatively, the flow of internal standard 130 may join sample delivery line 120 downstream of valve 104.

System 100 is configured to deliver a substantially continuous flow of liquid to nebulizer 122, set by the combined flow rates of third fluid pump 114 and fifth fluid pump 128 (if present), despite the discontinuous delivery of analysis samples from analysis sample loop 110. This arrangement is particularly desirable when analysis device 124 includes a plasma source for sample processing, because the constant flow of liquid assists to maintain stability of the plasma flame.

As depicted in FIG. 1, system 100 is configured such that the undiluted or diluted sample to be analysed is loaded into analysis sample loop 110 via port 1, and delivered for analysis out of port 1 (“last-in-first-out”). Alternatively, loading line 112 can be connected to port 5 and drain line 113 connected to port 6 of valve 104, such that the fluid to be analysed is loaded into analysis sample loop 110 via port 4, but still delivered for analysis out of port 1 (“first-in-first-out”).

Second multiport valve 106 is coupled to third multiport valve 108 via sample transfer line 132, which is connected to port 5 of valve 106 and port 6 of valve 108. Third multiport valve 108 is coupled to sample source 134 via sample source line 136, which is connected to port 5 of valve 108. Sample source 134 is configured to provide one or more external samples for analysis, and may be an autosampler adapted to sequentially sample a plurality of discrete external samples provided for analysis (e.g. in sample vials). However, sample source 134 is not so limited and could, for example, be an automation interface for periodic online monitoring of a process fluid, e.g. from a process stream in an industrial or food process.

As depicted in FIG. 1, first multiport valve 104, second multiport valve 106 and third multiport valve 108 are each in their first valve positions. Valve assembly 102 is thus configured to permit flow of an external sample along a continuous flow path from sample source 134 to analysis sample loop 110 (via sample source line 136, valve 108, sample transfer line 132, valve 106, loading line 112 and valve 104).

System 100 includes a fourth fluid pump 142, located downstream of first multiport valve 104 and in the flow path between valve 104 and drain 140 when bypass valve 138 is in a first configuration. Fourth fluid pump 142 may suitably be a high flow rate piston pump or vacuum pump (application dependent flow rate, e.g. 0 to 50 ml/min). When system 100 is configured as depicted in FIG. 1, fourth fluid pump 142 can thus be operated to flow an external sample (e.g. at a flow rate of about 30 ml/min) from sample source 134 directly through sample loop 110 and onward to drain 140, until an analysis sample representative of the external sample has been loaded into sample loop 110. Alternatively, a vacuum source may be used instead of fourth fluid pump 142 to suck the external sample through sample loop 110. In either case, the analysis sample thus loaded can then be analysed by switching first multiport valve 104 to the second valve position, as described herein and depicted in FIG. 2.

With valves 106 and 108 both maintained in their first valve positions, as depicted in FIGS. 1 and 2, one or more samples provided at sample source 134 can thus be analysed without in-line dilution, as described herein. Because of the continuous flow path from sample source 134 to analysis sample loop 110, the external sample(s) are advantageously flowed directly to the analysis sample loop without passing through a dilution module, thus minimising the time required for each analysis.

However, system 100 is also configurable to allow in-line dilution of one or more samples provided at sample source 134, for example to an instrument requested dilution level determined based on an initial analysis of the undiluted external sample as described herein.

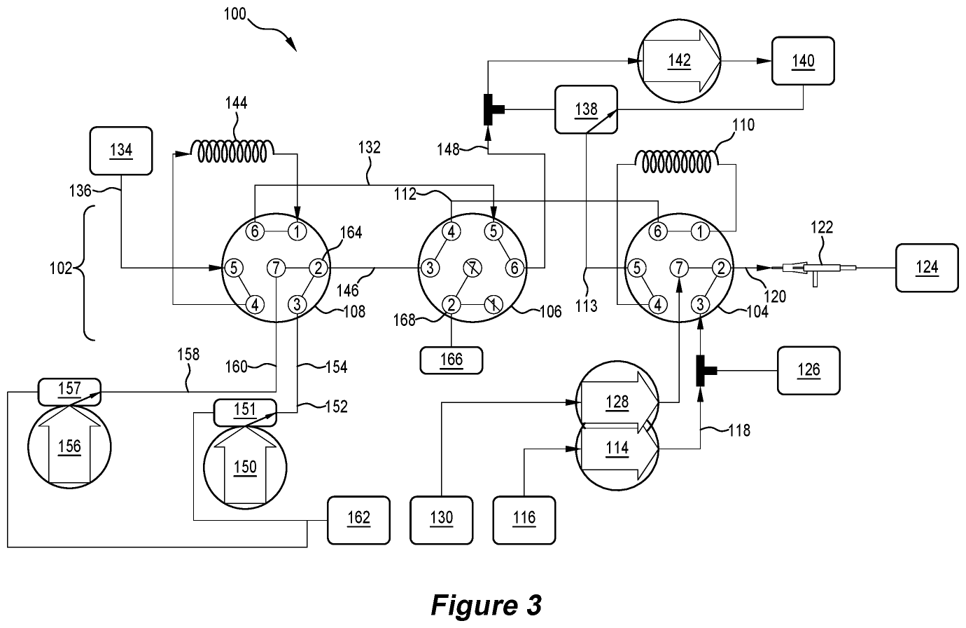

Thus, third multiport valve 108 is coupled to external sample reservoir 144, which is configured as a sample loop connected to ports 1 and 4 of valve 108. The sample loop may comprise a coil of thin tubing (e.g. 1 or 2 mm internal diameter) with sufficient volume to hold external sample for subsequent dilution and analysis in analysis device 124. When third multiport valve 108 and second multiport valve 106 are switched to their second valve positions, as depicted in FIG. 3, an external sample is loadable into external sample reservoir 144 by allowing fourth fluid pump 142 to flow the external sample (e.g. at a flow rate of about 30 ml/min) from sample source 134, via sample source line 136, external sample reservoir 144, sample transfer line 132, valve 106 and drain line 148 to drain 140, with the flow continued at least until external sample reservoir 144 holds a representative sample of the external sample. Valve assembly 102 is thus configurable to permit fourth fluid pump 142 to flow the external sample from sample source 134 to external sample reservoir 144.

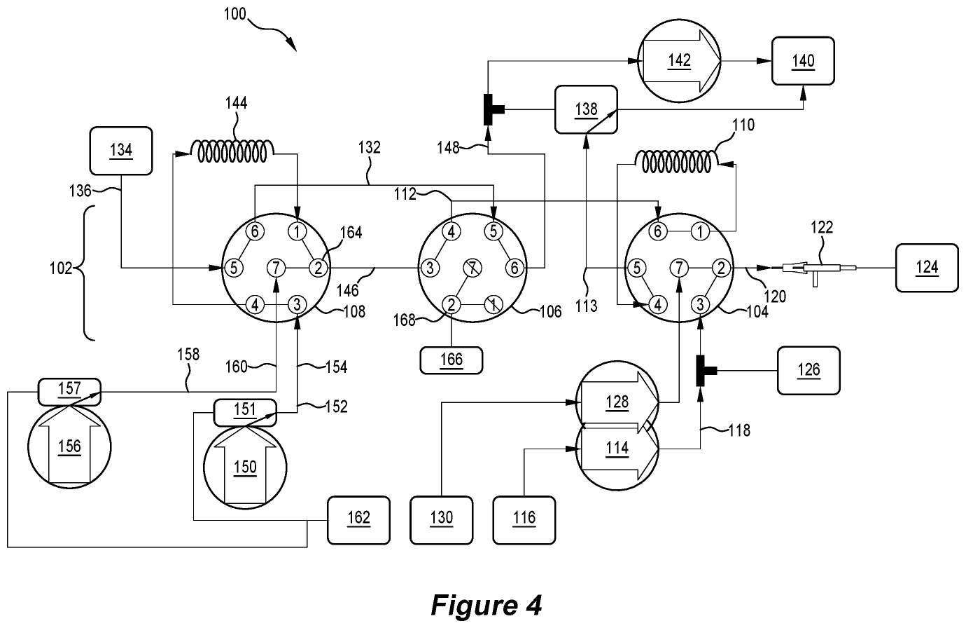

System 100 includes first fluid pump 150 to flow second carrier fluid 152 to third multiport valve 108 via carrier fluid line 154, entering at port 3. System 100 also includes second fluid pump 156 to flow diluent 158 to third multiport valve 108 via diluent fluid line 160, entering at port 7 and exiting from port 2 regardless of whether of valve 108 is in its first or second valve position, as depicted in FIGS. 3 and 4. First fluid pump 150 and second fluid pump 156, which may suitably be syringe pumps or other positive displacement pumps such as a piston pumps, are configured to accurately control the relative flow rates of second carrier fluid 152 and diluent 158 to achieve a target dilution of an external sample held in external sample reservoir 144.

In one implementation, first fluid pump 150 is controllable in a flow rate range of between 0.04 and 5.0 ml/min and a second fluid pump 156 is controllable in a flow rate range of between 5.0 and 9.96 ml/min, thus providing dilution factors in the range of 2 to 250 at a constant combined flow rate of 10 ml/min. In such an implementation, it has been found that the volume of external sample reservoir 144 can be approximately equal to that of analysis sample loop 110 (and could even be somewhat smaller) because of the minimum dilution factor of 2. By contrast, a significantly larger first sample loop would be required for prior art designs which cannot bypass the dilution module, because the first sample loop needs to be sized to transfer undiluted sample to the analysis sample loop. The present invention thus advantageously allows faster loading of smaller volumes of external sample into external sample reservoir 144 than is possible with prior art designs, with the extent of the advantage corresponding to the minimum dilution factor.

System 100 may include only a single first fluid pump 150 and a single second fluid pump 156, as depicted in the Figures, but it will be appreciated that system 100 could alternatively include two or more first fluid pumps 150 and/or two or more second fluid pumps 156, arranged in parallel and having different flow rate ranges. This may advantageously extend the range of relative flow rates (v/v) of second carrier fluid 152 and diluent 158 that can be delivered, thus allowing a wider range of sample dilutions to be achieved. First fluid pump 150 and second fluid pump 156 may obtain second carrier fluid 152 and diluent 158 from a single diluent source 162, as depicted in FIGS. 3 and 4, and indeed first carrier fluid 116 may also be obtained from the same source. However, it will be appreciated that second carrier fluid 152, diluent 158 and first carrier fluid 116 may in principle each be obtained from different sources and have different compositions.

Once external sample reservoir 144 holds a representative external sample loaded from sample source 134, third multiport valve 108 is switched back to its first valve position, as depicted in FIG. 4. First fluid pump 150 is activated to flow second carrier fluid 152 at a predetermined flow rate through external sample reservoir 144, pushing the external sample out of valve 108, exiting via port 2 into dilute sample transfer line 146. Second fluid pump 156 is activated to flow diluent 158 through valve 108, exiting via port 2 into dilute sample transfer line 146. Port 2 of valve 108 thus operates as sample dilution junction 164, where the external sample is contacted and mixed with diluent 158 to produce a diluted sample, the dilution level of which is controlled by the relative flow rates of second carrier fluid 152 and diluent 158.

System 100 may be configurable to introduce a gas bubble, for example air 166, to space apart second carrier fluid 152 and the external sample when second carrier fluid 152 flows through external sample reservoir 144. For example, after flushing second carrier fluid 152 and diluent 158 through valves 108 and 106 while both valves are in their second valve positions, e.g. as depicted in FIG. 3, second multiport valve 106 is switched to its first valve position and the flow direction of first fluid pump 150 and second fluid pump 156 is reversed. Air 166 is thus drawn into dilute sample transfer line 146 via gas inlet 168, with the reverse flow of liquid continuing until air is just withdrawn into carrier fluid line 154 and diluent fluid line 160, i.e. until gas bubbles just pass through ports 3 and 7 of valve 108, respectively. The resulting air bubbles thus physically space apart second carrier fluid 152 from the sample (one leading the diluted sample, one trailing the external sample) as the carrier fluid flows through external sample reservoir 144 and pushes the external sample to sample junction 164. This prevents or mitigates any undesired dilution of the external sample before the on-purpose dilution occurs at sample dilution junction 164.

As depicted in FIGS. 3 and 4, system 100 is configured such that the external sample is loaded into external sample reservoir 144 via port 4, and delivered to sample dilution junction 164 out of port 1 (“first-in-first-out”). Alternatively, sample source line 136 can be connected to port 6 and sample transfer line 132 connected to port 5 of valve 108, such that the external sample is loaded into analysis sample loop 110 via port 1 and delivered to sample dilution junction 164 out of port 1 (“last-in-first-out”).

With continued reference to FIG. 4, the diluted sample produced at sample dilution junction 164 is flowed via valve 106 (in its second valve position) and loading line 112 through analysis sample loop 110 to drain 140, with the flow continued at least until analysis sample loop 110 holds a representative sample of the diluted sample. Fourth fluid pump 142 is preferably bypassed by switching bypass valve 138 to its second configuration, since it is not needed to produce the flow and may interfere with the accurate operation of pumps 150 and 156.

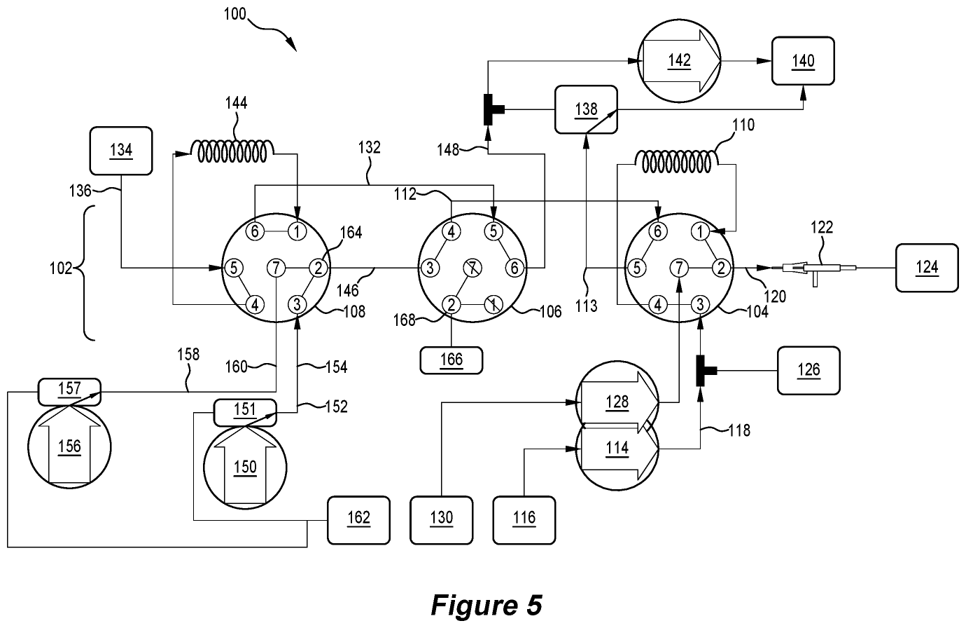

The analysis sample thus loaded in analysis sample loop 110 is then delivered via sample delivery line 120 to nebulizer 122 by switching first multiport valve 104 to its second valve position, as depicted in FIG. 5. With valve 108 in its second valve position, as also depicted in FIG. 5, external sample reservoir 144 may then be flushed with a rinse provided via sample source line 136, for example from the autosampler, during the analysis step. External sample reservoir 144 may then be reloaded with an external sample from sample source 134, thus facilitating a rapid turn-around between successive in-line dilution analyses. Optionally, the flow of second carrier fluid 152 and/or diluent 158 may be continued while analysing the diluted sample, thus flushing the diluted sample out of the flow path from sample dilution junction 164 to drain 140. If needed, pumps 150 and 156 can also be re-filled with second carrier fluid 152 and diluent 158 from diluent source 162 during the analysis step.

System 100 thus allows an external sample provided by sample source 134 to be accurately diluted in-line, if required. The in-line dilution occurs by a three-stage process (i.e. stage 1 of loading external sample into external sample reservoir 144; stage 2 of unloading the external sample reservoir, diluting the sample and re-loading into analysis sample loop 110, and stage 3 of unloading the diluted sample to analysis device 124). This necessarily increases the time taken per analysis. However, as described herein, system 100 is advantageously configured such that samples not requiring dilution, or requiring an initial analysis without dilution, can be analysed in only two stages by bypassing the dilution module comprising external sample reservoir 144, thus increasing the instrument productivity.

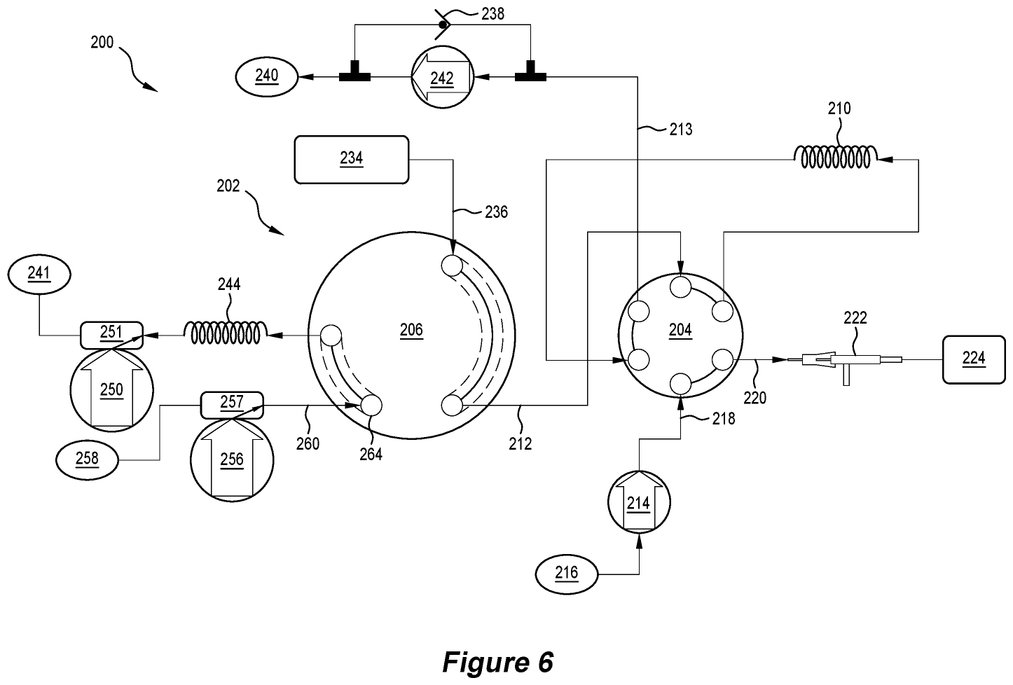

Depicted in FIGS. 6 to 9 is a sample delivery system 200 according to embodiments of the invention. System 200 includes a valve assembly 202 comprising first multiport valve 204 and second multiport valve 206. Valve 204 is switchable between first and second valve positions in which three internal flow channels of the valve provide a different set of connections between two ports of the valve. Valve 206 has two internal flow channels (depicted in dashed lines in FIGS. 6-9) and four ports, and is switchable between first, second and third valve positions in which the flow channels provide a different set of connections between the ports.

First multiport valve 204 is coupled to analysis sample loop 210, which comprises a coil of small diameter tubing with sufficient volume to hold an analysis sample for subsequent analysis in analysis device 224. Valve 204 is also coupled to second multiport valve 206 via loading line 212. When first multiport valve 204 is in its first valve position, as depicted in FIG. 6, an analysis sample is loadable into analysis sample loop 210 by flowing an undiluted or diluted sample to be analysed from loading line 212, through analysis sample loop 210 and out of valve 204 to drain line 213, with the flow continued at least until analysis sample loop 210 holds a representative sample.

System 200 further comprises third fluid pump 214 (e.g. a peristaltic pump) to flow first carrier fluid 216 (also known as a rinse) to first multiport valve 204 via carrier fluid line 218. When first multiport valve 204 is in its first valve position, as depicted in FIG. 6, pump 214 flows first carrier fluid 216 directly through valve 204 and via sample delivery line 220 to nebuliser 222.

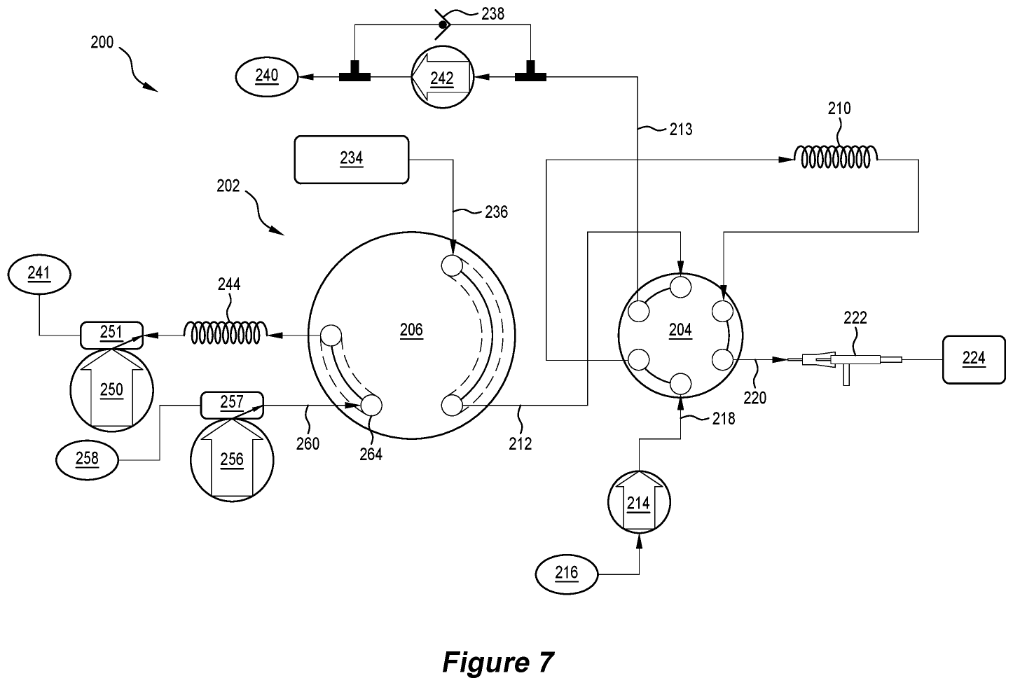

Once an analysis sample, representative of the undiluted or diluted sample to be analysed, has been loaded in analysis sample loop 210, the analysis sample is then delivered via sample delivery line 220 to nebulizer 222 by switching first multiport valve 204 to its second valve position, as depicted in FIG. 7. The flow of first carrier fluid 216 is thus diverted through analysis sample loop 210, pushing the analysis sample out of valve 204 via sample delivery line 220 to nebulizer 222, where it is nebulized and subsequently analysed in analysis device 224 (e.g. an ICP-OES or ICP-MS analyser).

As with system 100, system 200 may optionally include a bubble injector (not shown) configured to inject a spacer bubble of gas into carrier fluid line 218 immediately before its connection to 204, and a fluid pump to flow internal standard into sample delivery line 220 (also not shown). Analysis sample loop 210 may suitably be configured for either last-in-first-out or first-in-first-out operation.

Second multiport valve 206 is coupled to sample source 234 via sample source line 236. Sample source 234 is configured to provide one or more external samples for analysis, and may be an autosampler or other sample delivery device as disclosed herein. As depicted in FIG. 6, first multiport valve 204 and second multiport valve 206 are each in their first valve positions. Valve assembly 202 is thus configured to permit flow of an external sample along a continuous flow path from sample source 234 to analysis sample loop 210 (via sample source line 236, valve 206, loading line 212 and valve 204).

System 200 includes a fourth fluid pump 242, suitably a high flow rate piston pump or vacuum pump, located downstream of first multiport valve 204 and in the flow path between valve 204 and drain 240. Fourth fluid pump 242 can thus be operated to flow an external sample from sample source 234 directly through sample loop 210 and onward to drain 240, until an analysis sample representative of the external sample has been loaded into sample loop 210. The analysis sample thus loaded can then be analysed by switching first multiport valve 204 to the second valve position, as described herein and depicted in FIG. 7.

With valve 206 maintained in its first valve position, as depicted in FIGS. 6 and 7, one or more samples provided at sample source 234 can thus be analysed without in-line dilution, as described herein. Because of the continuous flow path from sample source 234 to analysis sample loop 210, the external sample(s) are advantageously flowed directly to the analysis sample loop without passing through a dilution module, thus minimising the time required for each analysis.

However, system 200 is also configurable to allow in-line dilution of one or more samples provided at sample source 234, for example to an instrument requested dilution level determined based on an initial analysis of the undiluted external sample as described herein.

Thus, second multiport valve 206 is coupled to external sample reservoir 244, which in system 200 is not configured as a sample loop connected to two ports of a multiport valve, but rather as a line coupled at one end to second multiport valve 206 and at the other end to switching valve 251 and first fluid pump 250. When switching valve 251 is configured to connect pump 250 to external sample reservoir 244 (as seen in the Figures), pump 250 is capable of flowing fluid in both directions: from valve 206 to fill external sample reservoir 244, and in reverse to accurately control the flow of external sample from external sample reservoir 244 for dilution. Pump 250 may thus be a syringe pump, or other positive displacement pump such as a piston pump, which is capable of accurately controlling fluid flow rates in the required ranges. External sample reservoir 244 may comprise a coil of small diameter tubing (e.g. 1 or 2 mm internal diameter) with sufficient volume to hold external sample for subsequent dilution and analysis in analysis device 224.

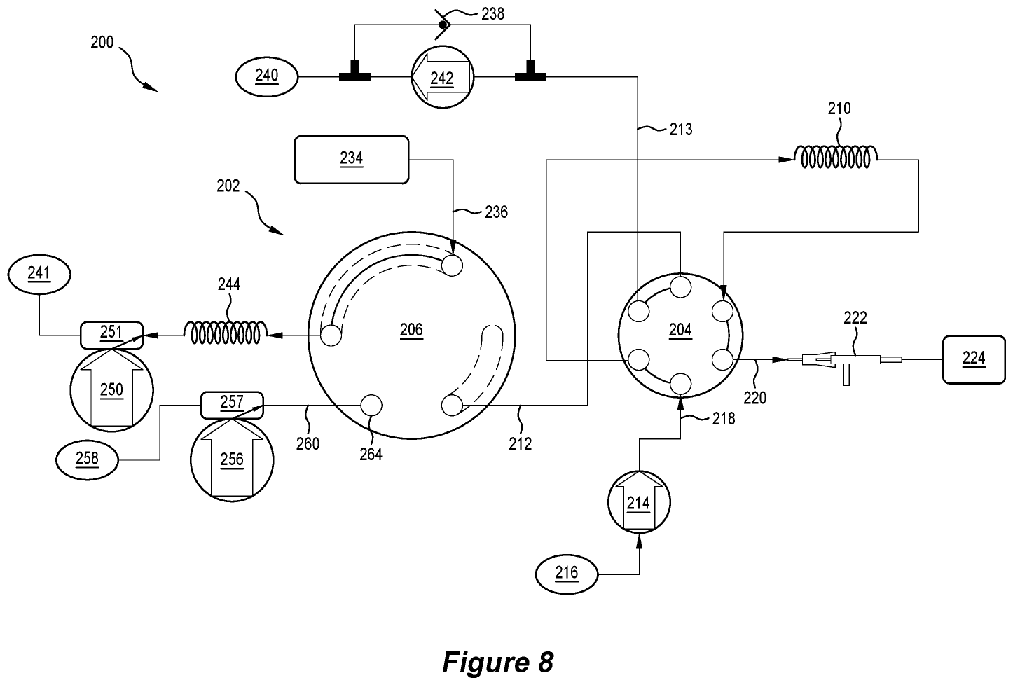

Preferably, the external sample to be diluted and analysed does not contact pump 250 during loading and unloading of external sample reservoir 244, thus avoiding contamination of the sample. In some embodiments, therefore, pump 250 may be operated with a carrier fluid in its internal volume, which has the additional advantage of minimising contamination of the pump. For example, with second multiport valve 206 switched to its third valve position as depicted in FIG. 8, pump 250 draws a carrier fluid supplied at sample source 234 into its internal volume through external sample reservoir 244 (optionally expelling excess carrier fluid to drain 241 as needed by reconfiguring switching valve 251). Alternatively, diluent 258 may be used to fill external sample reservoir 244 and pump 250 (with valve 206 in its first position as seen in FIG. 7).

With second multiport valve 206 in its third valve position, an external sample is loadable into external sample reservoir 244 from sample source 234, via sample source line 236, using pump 250. Preferably, carrier fluid previously loaded into external sample reservoir 244 is thus withdrawn into the internal volume of first fluid pump 250, with the flow stopped before the external sample enters switching valve 251. Optionally, a gas spacer bubble may be introduced to space apart the external sample from the carrier fluid, thus avoiding or acceptably limiting the mixing between the two fluids and ensuring that external sample reservoir 244 holds a representative aliquot of the external sample. Valve assembly 202 is thus configurable to permit first fluid pump 250 to flow the external sample from sample source 234 to external sample reservoir 244.

Optionally, external sample is loadable into external sample reservoir 244 while conducting the analysis of an analysis sample previously loaded into analysis sample loop 210. Thus, multiport valve 204 may be maintained in its second valve position, as seen in FIG. 8, and a continuing flow of first carrier fluid 216 to the nebuliser may be used to flush analysis sample loop 210 and the nebuliser while external sample reservoir 244 is loaded with a new external sample. Valve 204 may then be switched to its first valve position, ready for loading with another analysis sample.

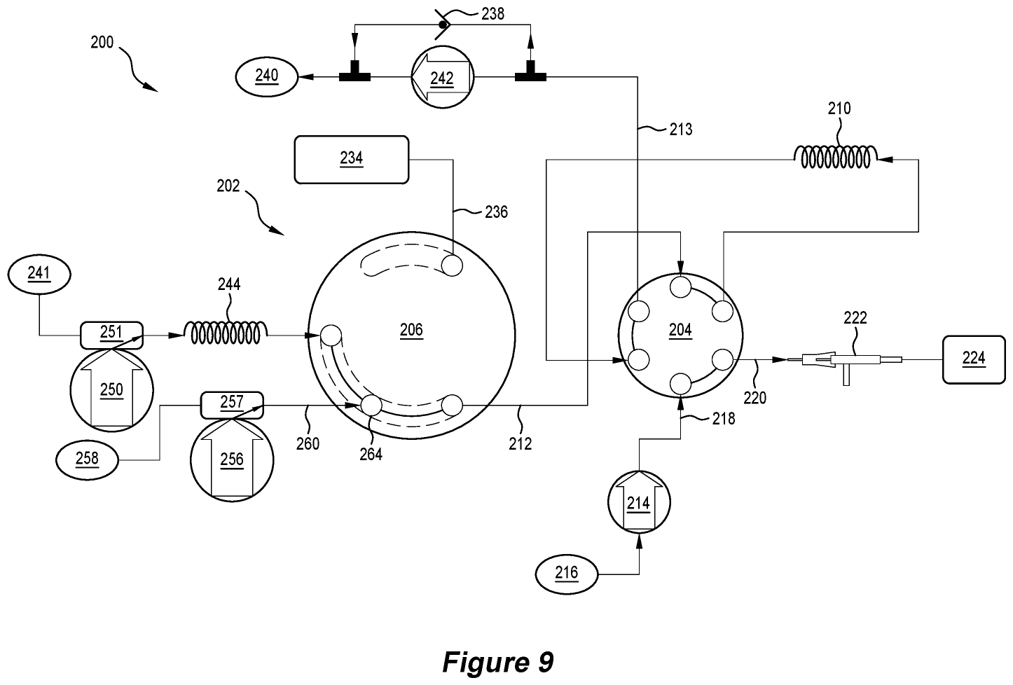

Once external sample reservoir 244 holds a representative external sample loaded from sample source 234, second multiport valve 206 is switched to its second valve position and first multiport valve 204 is switched to its first valve position (if not done already), as depicted in FIG. 9. First fluid pump 250 is activated to flow external sample from external sample reservoir 244 back to valve 206, typically pushing the external sample out using the carrier fluid inside the pump. Pump 250 is designed such that the reverse flow towards valve 206 required to transport external sample from external sample reservoir 244 for dilution never exceeds its internal volume. Second fluid pump 256 (suitably a syringe pump which is alternatively connectable via switching valve 257 to valve 206 or a source of diluent 258) is activated to flow diluent 258 to valve 206, where it contacts and dilutes the flow of external sample at sample dilution junction 264 inside valve 206 to produce a diluted sample. First fluid pump 250 and second fluid pump 256 are configured to accurately control the relative flow rates of external sample from external sample reservoir 244 and diluent 258 to achieve a target dilution.

System 200 may optionally be configurable to introduce spacer gas bubble(s), for example a bubble from diluent line 260 to lead the diluted sample and/or a bubble to trail the undiluted external sample, separating it from liquid in pump 250.

With continued reference to FIG. 9, the diluted sample produced at sample dilution junction 264 is flowed via loading line 212 through analysis sample loop 210 to drain 240 (preferably by-passing fourth fluid pump 242 via, for example, one-way valve 238 or alternatively a switching valve as depicted in FIGS. 1-5), with the flow continued at least until analysis sample loop 210 holds a representative sample of the diluted sample. Simultaneously, first carrier fluid (also known as rinse) is flowed directly through valve 204 to nebulizer 222. The analysis sample thus loaded in analysis sample loop 210 is then delivered via sample delivery line 220 to nebulizer 222 by switching first multiport valve 204 to its second valve position, as described herein.

Optionally, the flow of diluent 258 may be continued while analysing the diluted sample for a time sufficient to flush the remaining diluted sample out of the flow path from sample dilution junction 264 to drain 240. With valve 206 then switched to its third valve position (again as seen in FIG. 8), external sample reservoir 244 may then be flushed with a rinse provided via sample source line 236, for example from the autosampler. External sample reservoir 244 may then be reloaded with an external sample from sample source 234, thus facilitating a rapid turn-around between successive in-line dilution analyses. Alternatively, with valve 206 switched to its first valve position (again as seen in FIG. 7) loading line 212 may then be flushed with a rinse provided via sample source line 236, for example from the autosampler, in preparation for a subsequent analysis with or without dilution. External sample reservoir 244 may also be flushed with diluent 258, for example when analysing samples without dilution as described herein with reference to FIGS. 6 and 7.

System 200 thus allows an external sample provided by sample source 234 to be accurately diluted in-line, if required, in a dilution module comprising external sample reservoir 244. This necessarily increases the time taken per analysis. However, as described herein, system 200 is advantageously configured such that samples not requiring dilution, or requiring an initial analysis without dilution, can bypass external sample reservoir 144, thus increasing the instrument productivity.

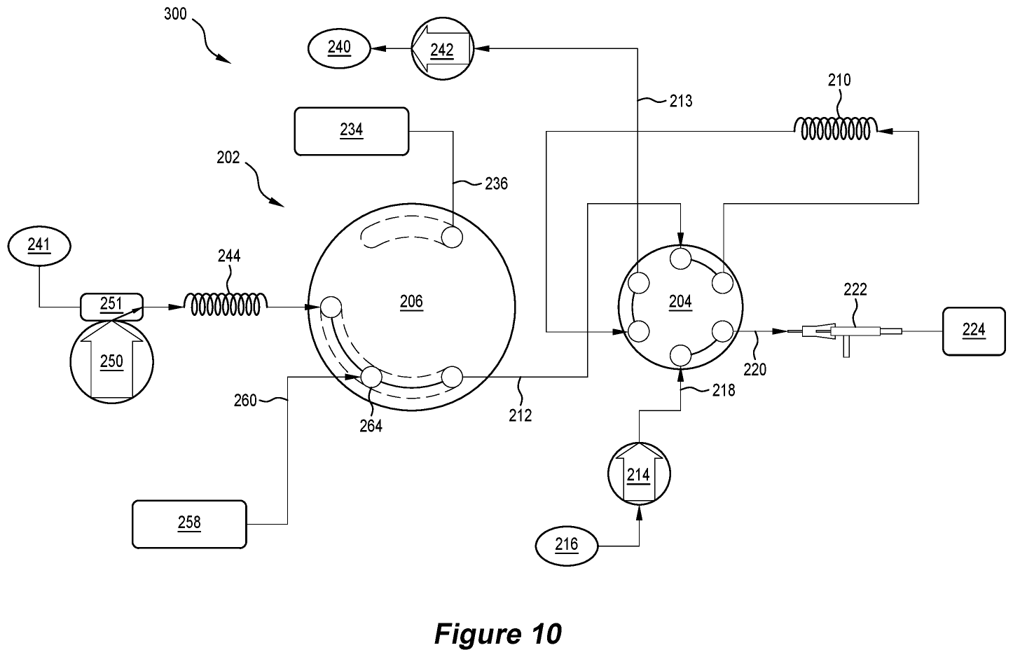

Depicted in FIG. 10 is sample delivery system 300 according to embodiments of the invention. System 300 is a variant of system 200 in which fluid pump 256, for pumping diluent 258, is absent. When in-line dilution of a sample is required, the external sample is loaded into external sample reservoir 244, as described herein for system 200. Second multiport valve 206 is then switched to its second valve position and first multiport valve is switched to its first valve position (if not done already), as depicted in FIG. 10. First fluid pump 250 is activated to flow external sample from external sample reservoir 244 back to valve 206. Fluid pump 242 (here operating in place of second fluid pump 256) is activated to flow diluted sample from sample dilution junction 264 via loading line 212 through analysis sample loop 210 to drain 240. Fluid pump 242 accurately controls the total diluted sample flow rate while first fluid pump 250 accurately controls the external sample flow rate. Diluent 258 is thus drawn to sample dilution junction 264 at the required flow rate, i.e. the difference between the flow rates of pumps 242 and 250. In this way, fluid pump 242 indirectly controls the flow of diluent 258 to the sample dilution junction, and thus the dilution level of the diluted sample loaded into analysis sample loop 210.

In system 300, fluid pump 242 thus plays two main roles: (1) loading of external sample into analysis sample loop 210 (when analysing undiluted samples), which operation is preferably fast but not necessarily accurate, and (2) controlling the flow of diluent (when analysing diluted samples), which operation is typically slower but must be accurate. Pump 242 may thus optionally be implemented as two pumps in parallel, to best achieve both objectives.

In another envisaged variation of system 200 (not shown), analysis sample loop 210 is replaced by an analysis sample reservoir in the form of a line coupled at one end to valve 204 and at the other end to first fluid pump 242. The diluted or undiluted sample to be analysed is thus pumped into the analysis sample reservoir by pump 242. When the resulting representative analysis sample is to be analysed, pump 242 reverses direction (simultaneously switching valve 204) so that the analysis sample flows to analyser 224. Pump 242 in this embodiment is designed such that the reverse flow to the analyser never exceeds its internal volume, so that a carrier fluid is not required to transport the analysis sample from analysis sample reservoir for analysis. Thus, in this embodiment, the analysis sample reservoir has a similar design and operation as does external sample reservoir 244.

### Spectrometer

The invention also relates to a spectrometer which comprises a sample delivery system as disclosed herein, and an analysis device. The analysis device may be permanently or removably coupled to the sample delivery line of the analysis sample device. In some embodiments, the analysis device is a conventional analysis device for a plasma spectrometer, therefore including components such as a nebulizer, a spray chamber to classify the aerosolised sample, a plasma torch (optionally powered by an RF generator) and an optical or ion mass detector. The spectrometer may be an ICP-OES and/or an ICP-MS spectrometer. It may alternatively be a microwave plasma spectrometer.

A computing device may be provided to control the operation of the spectrometer. The computing device may comprise one or more tangible non-transitory computer-readable media having computer-executable instructions for performing computer-implemented methods to control the operation of the spectrometer according to the principles disclosed herein. Typically, the computer implemented methods are automatically executed on a computer processor, either provided with or separately to the spectrometer. The computer processor may include a software application installed thereon for executing one or more of the steps of the computer implemented methods. In alternative embodiments, the software application may be a cloud-based application accessible via a network such as the internet. In some embodiments, the software application may be accessible remotely via a local network.

In some embodiments, the spectrometer controlled by the computing device is thus adapted to deliver an external sample for spectroscopic analysis by either method (a) or method (b). Method (a) is a computer-implemented method for spectroscopic analysis of an external sample without in-line dilution, and method (b) is a computer-implemented method for spectroscopic analysis of an external sample with in-line dilution.

Method (a) comprises:
(i) flowing the external sample along the continuous flow path from the sample source to the analysis sample reservoir, without dilution thereof, and
(ii) subsequently delivering the external sample from the analysis sample reservoir to the analysis device for spectroscopic analysis.

Method (b) comprises:
(i) flowing the external sample from the sample source to the external sample reservoir,
(ii) subsequently, flowing the external sample from the external sample reservoir to the sample dilution junction,
(iii) simultaneously, flowing diluent to the sample dilution junction, thereby diluting the external sample to produce a diluted sample,
(iv) flowing the diluted sample from the sample dilution junction to the analysis sample reservoir, and
(v) subsequently, delivering the diluted sample from the analysis sample reservoir to the analysis device for spectroscopic analysis.

In some embodiments, the spectrometer controlled by the computing device is adapted to deliver an external sample for spectroscopic analysis by method (a), to determine, based on the spectroscopic analysis of the external sample in method (a), a target dilution of the external sample, and to deliver a diluted sample, comprising the first external sample and the diluent, for spectroscopic analysis by method (b). The first fluid pump and the second fluid pump of the sample delivery device are thus controlled by the computing device to flow the first external sample and the diluent at relative flow rates suitable to achieve the target dilution in the diluted sample. Determining the target dilution may comprise determining that an analyte concentration in the external sample, as measured in method (a), is greater than a predetermined maximum concentration (e.g. an upper bound of a calibration range), and calculating or estimating the target dilution of the external sample such that the analyte concentration of the diluted sample is below the predetermined maximum concentration.

### Method of Analysis

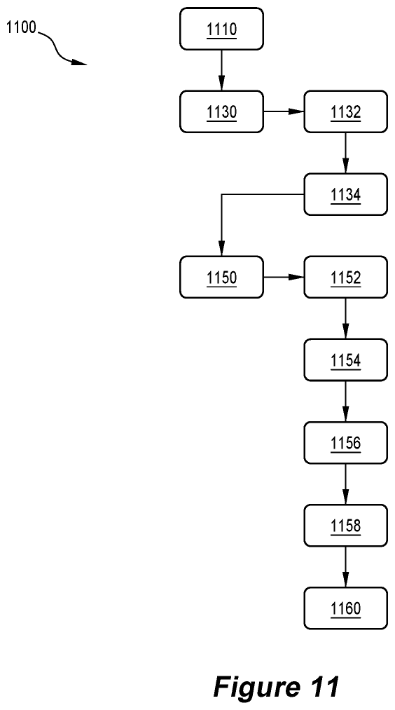

The invention also relates to a method of analysis using a spectrometer as disclosed herein. As schematically represented in FIG. 11, method of analysis 1100 comprises step 1110 of providing one or more external samples at a sample source for analysis and step 1130 of analysing at least a first sample of the one or more external samples, without dilution of the first sample, by a first analysis methodology. In some embodiments, method of analysis 1100 further comprises step 1150 of analysing at least the first sample or a second sample of the one or more external samples, with in-line dilution of the first or second sample, by a second analysis methodology.

The first analysis methodology of step 1130 comprises:
(i) sub-step 1132 of flowing the first sample along the continuous flow path from the sample source to the analysis sample reservoir, and
(ii) sub-step 1134 of subsequently delivering the first sample from the analysis sample reservoir to the analysis device for spectroscopic analysis.

The second analysis methodology of step 1150 comprises:
(i) sub-step 1152 of flowing the first or second sample from the sample source to the external sample reservoir,
(ii) sub-step 1154, subsequent to sub-step 1152, of flowing the first or second sample from the external sample reservoir to the sample dilution junction,
(iii) sub-step 1156, simultaneous to sub-step 1154, of flowing diluent to the sample dilution junction, thereby diluting the first or second sample to produce a diluted sample,
(iv) sub-step 1158 of flowing the diluted sample from the sample dilution junction to the analysis sample reservoir, and
(v) sub-step 1160, subsequent to sub-step 1158, of delivering the diluted sample from the analysis sample reservoir to the analysis device for spectroscopic analysis.

In some embodiments, method 1100 comprises determining, based on the spectroscopic analysis of the first sample in sub-step 1134, a target dilution of the first sample, and analysing the first sample (i.e. the same external sample) in step 1150 by the second analysis methodology. The first fluid pump and the second fluid pump of the sample delivery system are controlled in sub-steps 1154 and 1156 to flow the first sample and the diluent at relative flow rates suitable to achieve the target dilution in the diluted sample.

Determining the target dilution may comprise determining that an analyte concentration in the first sample is greater than a predetermined maximum concentration (e.g. an upper bound of a calibration range), and calculating or estimating the target dilution of the first sample such that the analyte concentration of the diluted sample produced in sub-step 1156 is below the predetermined maximum concentration. Methods according to such embodiments may thus be useful for in-line dilution of samples found in an initial analysis to be over-range in one or more analytes.

In some embodiments, method 1100 comprises providing a plurality of external samples at the sample source for analysis in step 1110, analysing the plurality of external samples by the first analysis methodology in step 1130, identifying, based on the spectroscopic analyses of the plurality of external samples obtained in sub-steps 1134, any over-range samples of the plurality of external samples having an analyte concentration greater than a predetermined maximum concentration (e.g. an upper bound of a calibration range), and analysing the over-range samples (if identified) by the second analysis methodology in step 1150. The first fluid pump and the second fluid pump are controlled in sub-steps 1154 and 1156 of the second analysis methodology to flow the over-range samples and the diluent at relative flow rates suitable to provide an analyte concentration of the diluted samples below the predetermined maximum concentration.

Methods according to such embodiments are useful for spectroscopic analysis of a series of external samples, and then re-analysing only those samples found to be over-range with appropriate in-line dilution to bring the analyte concentrations down to within the analysis range. This methodology provides excellent instrument productivity because the samples by-pass the dilution system of the sample delivery system in the initial analysis.

In some embodiments, the methods disclosed herein may be used to generate calibration data for a calibration curve. Thus method 1100 comprises providing a calibration sample at the sample source for analysis in step 1100, the calibration sample having a known concentration of one or more analytes, analysing the calibration sample by the first analysis methodology in step 1130, thereby delivering the calibration sample to the analysis device for spectroscopic analysis, and analysing the calibration sample one or more times by the second analysis methodology in step 1150, thereby delivering one or more diluted calibration samples having known concentrations of the one or more analytes to the analysis device for spectroscopic analysis.

A method of analysis according to an embodiment of method 1100 will now be described, with reference again to FIGS. 1 to 5, which depict an ICP-OES or ICP-MS spectrometer comprising a sample delivery system 100 and an analysis device 124.

This method comprises providing one or more external samples at sample source 134 for analysis (step 1110). Suitably, sampler 134 is an autosampler and a plurality of external samples are provided in the autosampler, e.g. in vials, for analysis. The method comprises analysing at least a first sample of those provided at sample source 134, without dilution of the first sample, by a first analysis methodology (step 1130). As required, the method may further comprise analysing at least the first sample or a second sample of the one or more external samples, with in-line dilution of the first or second sample, by a second analysis methodology (step 1150).

In step 1130, the first analysis methodology requires that second multiport valve 106 and third multiport valve 108 are maintained in their first valve positions, as depicted in FIGS. 1 and 2. First multiport valve 104 is also initially in its first valve position, as seen in FIG. 1, so that valve assembly 102 is configured to provide a continuous flow path from sample source 134 to analysis sample loop 110. Fourth fluid pump 142, located downstream of analysis sample loop 110, is activated to flow the first sample along the continuous flow path from sample source 134 to analysis sample loop 110 and on to drain 140 (sub-step 1132). The flow rate may be high, for example about 30 ml/min, to allow rapid loading of the first sample, and the flow is continued for a time sufficient to flush the lines and ensure that a representative aliquot of the first sample is obtained in analysis sample loop 110. Simultaneously, third fluid pump 114 and fifth fluid pump 128 flow constant flow rates of first carrier fluid 116 (e.g. 0.3 ml/min for ICP-MS and 1 ml/min for ICP-OES) and internal standard 130 through first multiport valve 104 to nebulizer 122.

Once a representative analysis sample of the first sample has been loaded in analysis sample loop 110, the analysis sample is then delivered via sample delivery line 120 to nebulizer 122 by switching first multiport valve 104 to its second valve position, as depicted in FIG. 2. The flow of first carrier fluid 116 is thus diverted through analysis sample loop 110, pushing the analysis sample out of valve 104 (where it mixes with the flow of internal standard) and via sample delivery line 120 to nebulizer 122, where it is nebulized and subsequently analysed in analysis device 124 for spectroscopic analysis (sub-step 1134). Optionally, a bubble is injected by bubble injector 126 as first multiport valve 104 is switched to its second valve position to physically space apart first carrier fluid 116 from the first sample.

After the first sample has been delivered for analysis, first multiport valve 104 is switched back to its first valve position, so that the flow of first carrier fluid 116 is again sent directly through valve 104 to the nebulizer. Optionally, the continuous flow path from sample source 134 to analysis sample loop 110, and onward to drain 140 is then flushed with a rinse between analyses. For example, the rinse may be provided from a rinse source in the autosampler.

With valves 106 and 108 both maintained in their first valve positions, as depicted in FIGS. 1 and 2, any number of the samples provided at sample source 134 can be sequentially analysed by the first analysis methodology, as described herein. Because of the continuous flow path from sample source 134 to analysis sample loop 110, the external sample(s) are advantageously flowed directly to analysis sample loop 110 without passing through external sample loop 144, thus minimising the total time required for each analysis.

In step 1150, a sample (either the first sample or a second sample) of the one or more external samples may be analysed by the second analysis methodology. Initiating the second analysis methodology requires that second multiport valve 106 and third multiport valve 108 are switched to their second valve positions, with first multiport valve 104 in its first valve position, as depicted in FIG. 3. Valve assembly 102 is thus configured to permit flow of external sample from sample source 134 to external sample reservoir 144. Fourth fluid pump 142 is activated to flow the first or second sample from sample source 134 to external sample reservoir 144 and on to drain 140 (sub-step 1152). The flow rate may be high, for example about 30 ml/min, to allow rapid loading of the sample, and the flow is continued for a time sufficient to flush the lines and ensure that a representative aliquot of the first or second sample is obtained in external sample reservoir 144.

The second methodology may also include a sub-step of preparing the delivery systems for second carrier fluid 152 and diluent 158. Thus, bypass valve 138 may be switched to its second configuration (as also seen in FIG. 3) and first fluid pump 150 and second fluid pump 156 may be activated to flush analysis sample loop 110 and other lines in the flow path to drain 140 with second carrier fluid 152 and diluent 158. Optionally, spacer gas bubbles may be introduced into carrier fluid line 154 and diluent fluid line 160 by temporarily switching second multiport valve 106 to its first valve position and reversing the flow direction of first fluid pump 150 and second fluid pump 156, as previously described herein.

Once external sample reservoir 144 holds a representative sample of the first or second sample, and the delivery systems for second carrier fluid 152 and diluent 158 are suitably prepared, third multiport valve 108 is switched back to its first valve position, as depicted in FIG. 4. First fluid pump 150 is activated to flow second carrier fluid 152 through external sample reservoir 144, pushing the first or second sample out of valve 108 via sample dilution junction 164 (sub-step 1154). Second fluid pump 156 is activated to flow diluent 158 through and out of valve 108 via sample dilution junction 164, thereby contacting and mixing the first or second sample with diluent 158 to produce a diluted sample (sub-step 1156). The dilution level of the diluted sample is controlled by the relative flow rates of second carrier fluid 152 and diluent 158.

With continued reference to FIG. 4, the diluted sample is flowed from sample dilution junction 164 via valve 106 (in its second valve position) to analysis sample loop 110 and on to drain 140, with the flow continued at least until analysis sample loop 110 holds a representative aliquot of the diluted sample (sub-step 1158). The diluted analysis sample thus loaded in analysis sample loop 110 is then delivered to nebulizer 122 by switching first multiport valve 104 to its second valve position (sub-step 1160), as depicted in FIG. 5 and in similar manner to that described herein for the first analysis methodology.

Valve 108 may be switched to its second valve position simultaneously with valve 104, as depicted in FIG. 5, so that the flow path from sample source 134 through external sample reservoir 144 and on to drain 140 may be flushed with a rinse between analyses. For example, the rinse may be provided from a rinse source in the autosampler. The flow of second carrier fluid 152 and/or diluent 158 may also be continued, thus flushing the diluted sample out of the flow path from sample dilution junction 164 to drain 140. If needed, pumps 150 and 156 can then be re-filled with second carrier fluid 152 and diluent 158 from diluent source 162.

External sample reservoir 144 may then be reloaded with another of the plurality of external samples provided at sample source 134, thus facilitating a rapid turn-around between successive in-line dilution analyses.

As will be apparent to the skilled person, a similar method of analysis (according to another embodiment of method 1100) can be performed with an ICP-OES or ICP-MS spectrometer comprising sample delivery system 200 or sample delivery system 300 and an analysis device 224, as depicted in FIGS. 6 to 10.

The methods of analysis previously described herein generally involve the analysis of one or more samples where at least one sample is spectroscopically analysed without in-line dilution. As previously explained, such methods advantageously allow rapid analysis of the undiluted samples because the external sample reservoir is by-passed when transferring sample from the sample source to the analysis sample reservoir. However, the sample delivery systems disclosed herein are also suitable for analysing a sample or a series of samples where each sample is diluted in-line to a prescribed dilution level, i.e. a dilution level which is not determined based on an initial undiluted analysis.

The present disclosure thus also provides methods of analysis using a spectrometer as disclosed herein, comprising: providing one or more external samples at a sample source for analysis, and analysing at least a first sample of the one or more external samples, with in-line dilution of the first sample, by an analysis methodology comprising: (i) flowing the first sample from the sample source to the external sample reservoir, (ii) subsequently flowing the first sample from the external sample reservoir to the sample dilution junction, (iii) simultaneously flowing diluent to the sample dilution junction, thereby diluting the first sample to produce a diluted sample, (iv) flowing the diluted sample from the sample dilution junction to the analysis sample reservoir, and (v) subsequently, delivering the diluted sample from the analysis sample reservoir to the analysis device for spectroscopic analysis.

Those skilled in the art will appreciate that the invention described herein is susceptible to variations and modifications other than those specifically described. It is understood that the invention includes all such variations and modifications which fall within the spirit and scope of the present invention.

1. A sample delivery system for an analytical instrument, comprising:
a valve assembly comprising one or more valves, the valve assembly configured to receive an external sample from a sample source;
an external sample reservoir coupled via the valve assembly to a sample dilution junction, wherein the valve assembly is configurable to alternatively permit either (i) flow of the external sample from the sample source to the external sample reservoir or (ii) flow of the external sample from the external sample reservoir to the sample dilution junction;
a first fluid pump to control a flow of the external sample from the external sample reservoir to the sample dilution junction;
a second fluid pump to control a flow of diluent to the sample dilution junction, thereby diluting the external sample to produce a diluted sample; and
an analysis sample reservoir configured to deliver an analysis sample contained therein to an analysis device of the analytical instrument, wherein the analysis sample reservoir is coupled via the valve assembly to the sample dilution junction, and wherein the valve assembly is configurable to alternatively permit either (i) flow of the external sample along a continuous flow path from the sample source to the analysis sample reservoir, thereby by-passing the external sample reservoir, or (ii) flow of the diluted sample from the sample dilution junction to the analysis sample reservoir.

2. The sample delivery system according to claim 1, wherein the analysis sample reservoir is configured as an analysis sample loop coupled to two ports of a first multiport valve of the valve assembly, wherein an analysis sample is loadable into the analysis sample loop when the first multiport valve is in a first valve position and wherein the analysis sample is deliverable from the analysis sample loop to the analysis device when the first multiport valve is switched to a second valve position.

3. The sample delivery system according to claim 2, further comprising a third fluid pump to flow a first carrier fluid to the first multiport valve, wherein the first multiport valve is configurable to flow the first carrier fluid directly through the first multiport valve to the analysis device when the first multiport valve is in the first valve position and to divert the first carrier fluid through the analysis sample loop when the first multiport valve is switched to the second valve position, thereby delivering the analysis sample from the analysis sample loop to the analysis device.

4. The sample delivery system according to claim 3, further comprising a bubble injector configured to inject a bubble of gas to space apart the first carrier fluid from the analysis sample when the first carrier fluid flows through the analysis sample loop.

5. The sample delivery system according to claim 1, further comprising a fourth fluid pump or vacuum source to flow the external sample along the continuous flow path from the sample source to the analysis sample reservoir.

6. The sample delivery system according to claim 5, which is adapted to bypass the fourth fluid pump or vacuum source when the diluted sample is flowed from the sample dilution junction to the analysis sample reservoir.

7. The sample delivery system according to claim 5, wherein the valve assembly is configurable to permit the fourth fluid pump or vacuum source to flow the external sample from the sample source to the external sample reservoir.

8. The sample delivery system according to claim 1, wherein the valve assembly is configurable to permit the first fluid pump to flow the external sample from the sample source to the external sample reservoir.

9. The sample delivery system according to claim 1, wherein the valve assembly comprises a second multiport valve coupled to the analysis sample reservoir, wherein the second multiport valve is switchable between at least a first valve position to permit the flow of the external sample along the continuous flow path from the sample source to the analysis sample reservoir and a second valve position to permit the flow of the diluted sample from the sample dilution junction to the analysis sample reservoir.

10. The sample delivery system according to claim 9, wherein the second multiport valve is switchable to a third valve position to permit the flow of the external sample from the sample source to the external sample reservoir.

11. The sample delivery system according to claim 10, wherein the second fluid pump controls the flow of diluent through the second multiport valve to the sample dilution junction when the second multiport valve is switched to the second valve position.

12. The sample delivery system according to claim 1, wherein the external sample reservoir is configured as an external sample loop coupled to a valve of the valve assembly.

13. The sample delivery system according to claim 1, wherein the external sample reservoir is configured as an external sample loop coupled to two ports of a third multiport valve of the valve assembly, wherein the external sample is loadable into the external sample loop when the third multiport valve is in a second valve position and wherein the external sample is deliverable from the external sample loop to the sample dilution junction when the third multiport valve is switched to a first valve position.

14. The sample delivery system according to claim 13, wherein the valve assembly is configurable to permit the first fluid pump to flow a second carrier fluid through the external sample loop when the third multiport valve is switched to the first valve position, thereby flowing the external sample from the external sample loop to the sample dilution junction.

15. The sample delivery system according to claim 14, which is configurable to introduce a gas bubble to space apart the second carrier fluid and the external sample when the second carrier fluid flows through the external sample loop.

16.-22. (canceled)

23. A spectrometer comprising a sample delivery system according to claim 1, and an analysis device.

24.-25. (canceled)

26. The spectrometer according to claim 23, further comprising a computing device for controlling the sample delivery system to deliver an external sample for spectroscopic analysis wherein the spectrometer is configured to:
(i) flow the external sample along the continuous flow path from the sample source to the analysis sample reservoir, without dilution thereof, and (ii) subsequently deliver the external sample from the analysis sample reservoir to the analysis device for spectroscopic analysis.

27. (canceled)

28. The spectrometer according to claim 23, comprising wherein the spectrometer is configured to:
provide one or more external samples at a sample source for analysis;
analyze at least a first sample of the one or more external samples without dilution of the first sample;
flow the first sample along the continuous flow path from the sample source to the analysis sample reservoir; and
subsequently deliver the first sample from the analysis sample reservoir to the analysis device for spectroscopic analysis.

29. The spectrometer according to claim 28, wherein the spectrometer is configured to:
analyze at least the first sample or a second sample of the one or more external samples with in-line dilution of the first or second sample;
flow the first or second sample from the sample source to the external sample reservoir;
subsequently flow the first or second sample from the external sample reservoir to the sample dilution junction;
simultaneously flow diluent to the sample dilution junction, thereby diluting the first or second sample to produce a diluted sample;
flow the diluted sample from the sample dilution junction to the analysis sample reservoir; and
subsequently deliver the diluted sample from the analysis sample reservoir to the analysis device for spectroscopic analysis.

30. The spectrometer according to claim 23, further comprising a computing device for controlling the sample delivery system to deliver an external sample for spectroscopic analysis, wherein the spectrometer is configured to:
flow the external sample from the sample source to the external sample reservoir;
subsequently flow the external sample from the external sample reservoir to the sample dilution junction;
simultaneously flow diluent to the sample dilution junction, thereby diluting the external sample to produce a diluted sample;
flow the diluted sample from the sample dilution junction to the analysis sample reservoir; and
subsequently delivering the diluted sample from the analysis sample reservoir to the analysis device for spectroscopic analysis.

31.-32. (canceled)
